(19) United States
(12) Patent Application Publication
(10) Pub. No.: US 2014/0103276 A1
(43) Pub. Date: Apr. 17, 2014

(54) Hand Implement

(71) Applicant: Peter Dominic Fegan, Queensland (AU)

(72) Inventor: Peter Dominic Fegan, Queensland (AU)

(21) Appl. No.: 14/052,734

(22) Filed: Oct. 12, 2013

(30) Foreign Application Priority Data
Oct. 12, 2012 (AU) 2012904481

(51) Int. Cl. B25G 1/10; B25D 1/04

(52) U.S. Cl. CPC B25G 1/102; B25D 1/04
USPC 254/26 R; 16/430; 81/489

(57) ABSTRACT

The present invention relates to a handle for a hand implement. The handle defines thumb indentations for receiving a thumb. Advantageously, the thumb can be positioned in particular thumb indentations to suit user preference or functional operation of the implement. Preferably, the handle defines a bight opposite the thumb indentations. The handle may define finger indentations in the bight. The finger indentations may be located closer a free end of the handle than the thumb indentations.

### TECHNICAL FIELD

The present invention generally relates to hand implements including hand tools. The present invention has particular, although not exclusive application to hammers.

### PRIORITY

This application claims the priority of a foreign application, namely Australian Patent Application No. 2012904481, under 35 U.S.C. 119(b) and 37 CFR 1.55(d).

### BACKGROUND

The reference to any prior art in this specification is not, and should not be taken as an acknowledgement or any form of suggestion that the prior art forms part of the common general knowledge.

Since the dawn of time, humans have used hand operated implements and tools to assist in daily activities. For example, builders use a vast array of hand tools including hammers and trowels throughout the day. Undesirably, the actions performed by many hand tools are repetitive. Further, some tools such as hammers involve high impact or stresses on the hand which can result in long term injury.

Additionally, women are often reluctant to use hand tools and are therefore more inclined to call upon a handyman, even for small tasks.

The applicant has perceived a need for an ergonomic hand implement which is well suited to use by women. The preferred embodiment provides such an implement in the form of a claw hammer.

### SUMMARY OF THE INVENTION

According to one aspect of the present invention, there is provided a handle for a hand implement, the handle comprising thumb indentations for receiving a thumb. Advantageously, the thumb can be positioned in particular thumb indentations to suit user preference or functional operation of the hand implement.

The handle may comprise a bight opposite the thumb indentations. The handle may comprise an enlarged free end to impede slipping of the hand. The handle may define finger indentations in the bight. The finger indentations may be located closer the free end than the thumb indentations. The handle may comprise a necking adjacent the finger indentations to facilitate gripping between a thumb and a pointer finger.

The handle may generally curve one-way and then another in an “S” like manner. The handle can comprise a magnesium core coated with a protective coating. The protective coating can comprise titanium. The handle may comprise an over-molded grip. A working end of the handle may comprise a truss.

According to another aspect of the present invention, there is provided a hand implement comprising the handle.

The hand implement may be a claw-hammer comprising a head. The head may comprise an aperture. The head may be integrally formed with the handle. The free end of the handle may curve toward the front of the hammer. The fixed end of the handle may curve toward the rear of the hammer.

According to another aspect of the present invention, there is provided a handle for a hand implement, the handle comprising a bight with a plurality of finger indentations.

According to another aspect of the present invention, there is provided a handle for a hand implement, the handle comprising a necking adjacent the finger indentations to facilitate gripping between a thumb and a pointer finger.

According to another aspect of the present invention, there is provided a handle for a hand implement, the handle comprising a truss.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an upper perspective view of a claw hammer in accordance with an embodiment of the present invention;

FIG. 2 is a lower perspective view of the claw hammer of FIG. 1;

FIG. 3 is a front view of the claw hammer of FIG. 1;

FIG. 4 is a rear view of the claw hammer of FIG. 1; and

FIG. 5 is a side view of the claw hammer of FIG. 1.

### DETAILED DESCRIPTION OF PREFERRED EMBODIMENTS

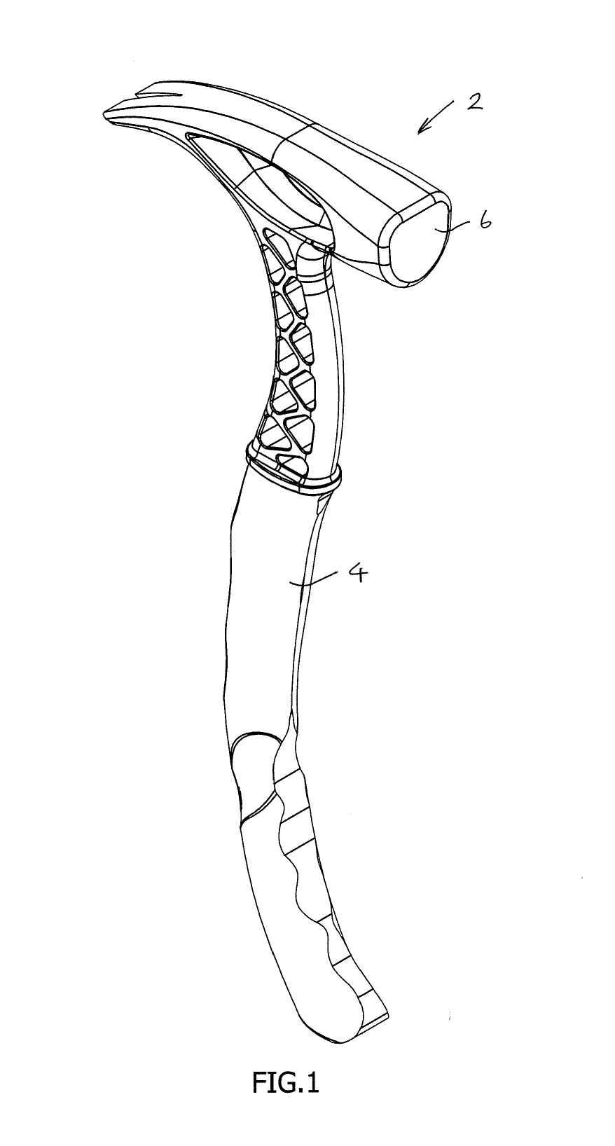

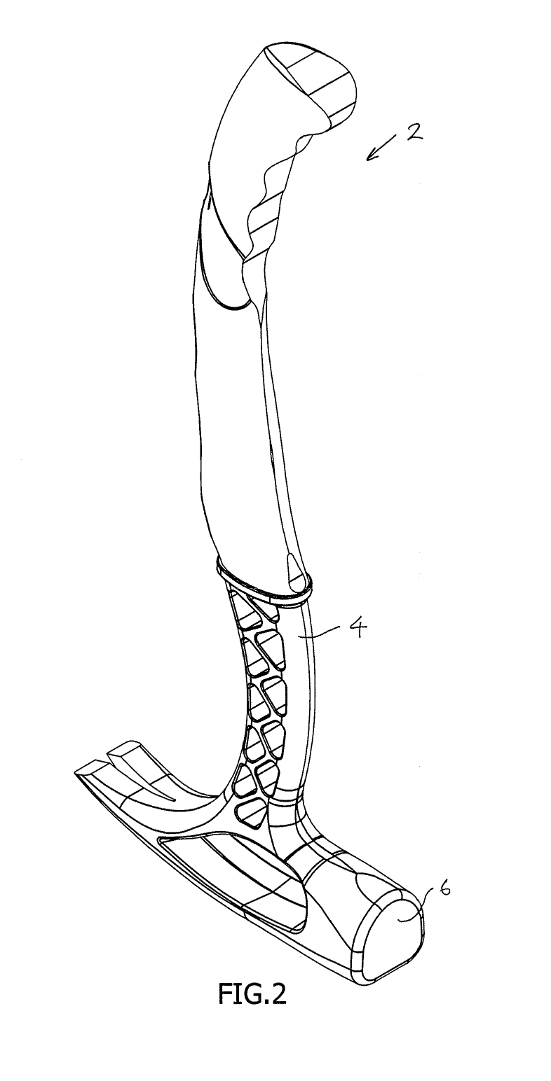

According to an embodiment of the present invention, there is provided a claw-hammer 2 as shown in FIGS. 1 to 5. Turning to FIGS. 1 and 2, hammer 2 has a generally S-shaped handle 4 extending from a head 6.

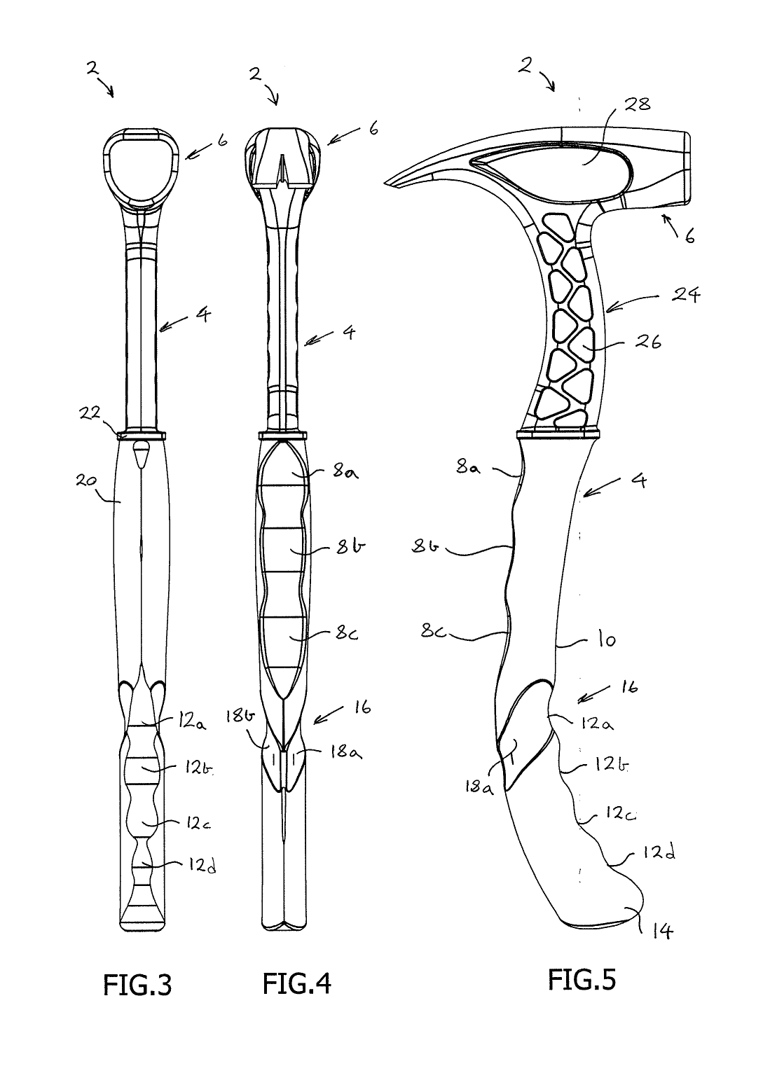

As can best be seen in FIGS. 4 and 5, the handle 4 defines comprises a three thumb plurality of indentations 8a, 8b, 8c for receiving a thumb. Turning to FIG. 5, the handle 4 defines a lower bight 10 opposite of the thumb indentations 8a, 8b, 8c. As can best be seeing in FIGS. 3 and 5, the handle 4 also can comprise four plurality of finger indentations 12a, 12b, 12c, 12d in the lower end of the bight 10 closer to the free end than the thumb indentations 8a, 8b, 8c. At the free end, the base of the handle 4 defines an enlarged deer-foot 14 to impede slipping of the handle 4 from the hand in use.

Turning to FIGS. 4 and 5, the handle 4 defines a necking 16 adjacent the to each of finger indentations 12a, 12b, 12c to facilitate gripping between a thumb and pointer finger. The necking 16 can comprise two opposite slots 18a, 18b that extend upwardly toward the front of the hammer 2.

The lower free end of the handle 4 curves toward the front of the hammer 2 whereas the upper fixed end of the handle 4 curves toward the rear of the hammer 2. In this manner, the handle 4 generally curves one way and then the other in an “S” like manner. The handle 4 can comprise a magnesium core coated with a titanium protective coating. Advantageously, the magnesium core is lightweight and provides desirable vibration dampening properties.

As shown in FIG. 3, the handle 4 also can comprise a lower rubber over-molded grip 20 extending down from a top rib 22 and encapsulating the free end of the magnesium core. The handle 4 and head 6 are integrally formed of magnesium (i.e. cast or formed of a single piece) prior to the application of the grip 20.

As can best be seen in FIG. 5, the upper working end of the handle 4 can define a truss 24, in turn, defining a number of apertures 26. The head 6 also can define an aperture 28. The apertures 26, 28 generally have rounded corners to minimize fracturing owing to stresses and advantageously reduce the weight of the upper portion of the hammer 2. Further, the apertures 26, 28 serve to dampen vibrations when compared with alternative solid handles.

The hammer provides a lightweight and ergonomic design, and is particularly well suited to operation by women owing to its light weight and guide indentations.

In use when hammering a nail, the user's hand is initially positioned in the middle of the handle 4 with the thumb engaged in one of the thumb indentations 8a, 8b, 8c when lightly tapping the nail. The thumb can be placed in any one of the indentations 8a, 8b, 8c based upon preference, or can later be placed in lower thumb indentations 8b and then 8c to increase the nail tapping force.

Once the nail is tapped so that it is retained in wood, the hand may grip the base of the hammer 2 to drive the nail. A V-grip is adopted with the thumb and pointer finger engaged in the slots 18a, 18b of the necking 16, and the pointer, middle, ring and small fingers located in respective finger indentations 12a, 12b, 12c, 12d. The enlarged deer-foot 14 impedes slipping of the handle 4 from the hand when firmly driving the nail.

The ergonomic and vibration-dampening handle 4 provides for a more user-friendly hammer 2 with more comfortable grip when compared with prior art hammers. The user relaxes with a more natural handgrip when using the hammer 2, which desirably reduces muscle strain and the potential for injury.

A person skilled in the art will appreciate that many embodiments and variations can be made without departing from the ambit of the present invention.

In one embodiment, the handle 4 can comprise titanium, fiberglass or steel.

The preferred embodiment was described in relation to a hammer. The present invention has application to other hand implements including, for example, a hatchet, trowel, chisel, knife, and cooking pot.

In compliance with the statute, the invention has been described in language more or less specific to structural or methodical features. It is to be understood that the invention is not limited to specific features shown or described since the means herein described comprises preferred forms of putting the invention into effect.

1. A handle for a hand instrument comprising
a plurality of thumb indentations, each of said thumb indentations capable of receiving a thumb.

2. The handle of claim 1, further comprising a bight opposite of said thumb indentations.

3. The handle of claim 2, further comprising a plurality of finger indentations in the bight.

4. The handle of claim 3, further comprising a free end wherein each of said finger indentations are located closer a free end of said handle than said thumb indentations.

5. The handle of claim 3, further comprising a necking adjacent said finger indentations to facilitate gripping between a thumb and pointer finger.

6. The handle of claim 1, further comprising an enlarged free end to impede slipping of the hand.

7. The handle of claim 1, further comprising a member having an “S” curve.

8. The handle of claim 1, further comprising a magnesium core and a protective coating that coats said magnesium core.

9. The handle of claim 8, wherein said protective coating comprises titanium.

10. The handle of claim 1, further comprising an over-molded grip.

11. The handle of claim 1, further comprising a working end, said working end comprising a truss.

12. A hand implement comprising a handle, said handle comprising a plurality of thumb indentations capable of receiving a thumb.

13. The hand implement of claim 12, further comprising a claw-hammer head.

14. The hand implement of claim 13, wherein said head comprises an aperture.

15. The hand implement of claim 13, wherein said head is integrally formed with said handle.

16. The hand implement of claim 12, wherein a free end of said handle curves toward the front of said hand implement.

17. The hand implement of claim 12, wherein a fixed end of said handle curves toward the rear of said hand implement.

18. A handle for a hand implement, said handle comprising a bight, said bight comprising a plurality of finger indentations.
